(19) United States
(12) Patent Application Publication
(10) Pub. No.: US 2021/0265067 A1
(43) Pub. Date: Aug. 26, 2021

(54) COMMUNICATION METHOD AND SYSTEM FOR SMART DEVICES OF INTERNET OF THINGS BASED ON VIRTUAL SIM CARDS

(71) Applicant: JRD COMMUNICATION (SHENZHEN) LTD, Shenzhen, Guangdong (CN)

(72) Inventors: Xianghui Lou, Shenzhen, Guangdong (CN); Dong Jiang, Shenzhen, Guangdong (CN)

(73) Assignee: JRD COMMUNICATION (SHENZHEN) LTD, Shenzhen, Guangdong (CN)

(21) Appl. No.: 16/321,486

(22) PCT Filed: Jul. 25, 2017
(86) PCT No.: PCT/CN2017/094261

§ 371 Date: Jan. 29, 2019

(30) Foreign Application Priority Data
Sep. 14, 2016 (CN) 201610823474.5

(51) Int. Cl. G16Y 40/35; H04W 8/18; H04W 8/20

(52) U.S. Cl. CPC G16Y 40/35; H04W 8/265; H04W 8/205; H04W 8/183

(57) ABSTRACT

The present disclosure discloses a communication method for smart device of IOT based on virtual SIM cards, wherein the method includes the following actions: a smart terminal receives SIM information resource allocated by an operator and transmits the SIM information resource to a corresponding smart device of IOT; the smart device of IOT writes received SIM information resource into a virtual SIM card; the smart terminal transmits activation instruction to the smart device of IOT; the smart device of IOT activates the virtual SIM card according to the received activation instruction, and thus connects a corresponding operator network.

### TECHNICAL FIELD

The present disclosure relates to a field of communication for smart devices, and more particularly, to a communication method and system for smart devices of internet of things based on virtual SIM cards.

### BACKGROUND

With the emergence of new business modes and application scenarios and the continuous development of the technology of internet of things (IOT), particularly, increasing expansion of smart devices of IOT, conventional SIM cared cannot meet requirements of some markets well. For example, some IOT devices (e.g., smart watches) have high requirements for volume, if conventional SIM cards are inserted, it will bring great difficulty into the design of smart watches, and the design cost is increased; some IOT devices are deployed at locations where it is inconvenient to insert cards or replace cards manually, and the users usually select operators after deploying terminals, when insertion or replacement of conventional SIM cards are performed, it will bring great inconvenience to the use of IOT devices, and conventional SIM cards in IOT devices have risk of being stolen or misappropriated.

Therefore, the related art still needs to be improved and developed.

### SUMMARY

In view of the shortcomings of the above related art, a purpose of the present disclosure is to provide a communication method and system for smart devices of IOT based on virtual SIM cards, which aims at solving the problem that conventional SIM cards bring inconvenience into use of smart devices of IOT.

A technical solution of the present disclosure is as follows:

A communication method for smart devices of TOT based on virtual SIM cards, the method including the following actions.

A, a smart terminal receiving SIM information resource allocated by an operator and transmitting the SIM information resource to a corresponding smart device of IOT.

B, the smart device of IOT writing the received SIM information resource into a virtual SIM card.

C, the smart terminal transmitting activation instruction to the smart device of IOT.

D, the smart device of TOT activating the virtual SIM card according to the received activation instruction, and connecting a corresponding operator network.

E, the smart terminal transmitting de-activation instruction to the smart device of TOT, and the smart device of IOT de-activating the virtual SIM card according to the de-activation instruction, and stopping using the virtual SIM card to connect the operator network.

F, the smart terminal transmitting deletion instruction to the smart device of IOT, and the smart device of IOT deleting the SIM information resource in the virtual SIM card according to the deletion instruction.

A communication method for smart devices of TOT based on virtual SIM cards, the method including the following actions.

A, a smart terminal receiving SIM information resource allocated by an operator and transmitting the SIM information resource to a corresponding smart device of IOT.

B, the smart device of IOT writing the received SIM information resource into a virtual SIM card.

C, the smart terminal transmitting activation instruction to the smart device of IOT.

D, the smart device of TOT activating the virtual SIM card according to the received activation instruction, and connecting a corresponding operator network.

A communication system for smart devices of IOT based on virtual SIM cards, comprising a smart terminal and a smart device of IOT, wherein the smart terminal comprises a transceiver module and an activation instruction transmission module, and the smart device of IOT comprises a writing module and an activation module.

The transceiver module is configured to receive SIM information resource allocated by an operator and transmit the SIM information resource to a corresponding smart device of IOT.

The writing module is configured to write the received SIM information resource into a virtual SIM card.

The activation instruction transmission module is configured to transmit activation instruction to the smart device of IOT.

The activation module is configured to activate the virtual SIM card according to the received activation instruction and thus connect a corresponding operator network.

Beneficial effects: the communication method and system for smart devices of IOT based on virtual SIM cards provided by the present disclosure realizes that a smart device of IOT without any entitative SIM card inserted therein still may perform mobile communication independently based on a virtual SIM card after leaving a smart terminal, and supports remote distribution and management for SIM information of the smart device of IOT. By the present disclosure, the configuration of SIM card slots may be decreased from smart devices of IOT, not only are the space and production cost of smart devices of IOT saved, but also the appearances of smart devices of IOT can become more flexible, this is of great importance for smart devices of IOT, such as smart watches, motion recorders, smart meters, and so on, which have high requirements for volume and are inconvenient for inserting or replacing cards.

### BRIEF DESCRIPTION OF THE DRAWINGS

FIG. 1 is a schematic view of a flowchart of a preferred embodiment of a communication method for smart devices of IOT based on virtual SIM cards of the present disclosure.

FIG. 2 is a structural schematic view of a preferred embodiment of a communication system for smart devices of IOT based on virtual SIM cards of the present disclosure.

### DETAILED DESCRIPTION

The present disclosure provides a communication method and system of smart devices of IOT based virtual SIM cards. In order to make purposes, technical solutions, and effects of the present disclosure be clearer and more explicit, the present disclosure will be further described in detail below. It should be understood that the specific embodiments described here are merely intended to illustrate, but not to limit, the present disclosure.

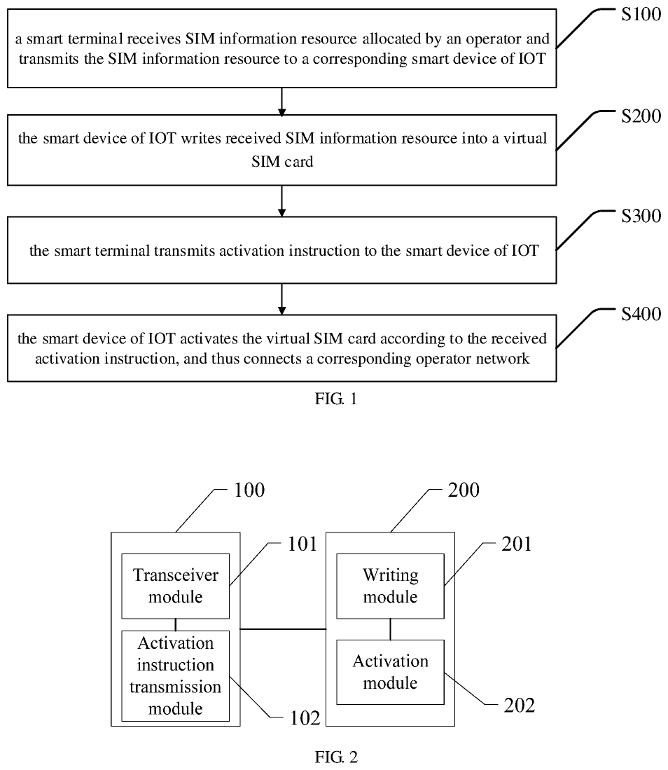

Referring to FIG. 1, FIG. 1 is a schematic view of a flowchart of a preferred embodiment of a communication method for smart devices of IOT based on virtual SIM cards of the present disclosure. As shown in the figure, the method may include following blocks.

In block S100, a smart terminal receives SIM information resource allocated by an operator and transmits the SIM information resource to a corresponding smart device of IOT.

In block S200, the smart device of IOT writes received SIM information resource into a virtual SIM card.

In block S300, the smart terminal transmits activation instruction to the smart device of IOT.

In block S400, the smart device of IOT activates the virtual SIM card according to the received activation instruction, and thus connects a corresponding operator network.

Conventional entitative SIM (Subscriber Identity Module) cards are also called as user identity recognition cards or smart cards, a mobile phone must be equipped with a SIM card for communication. A chip of the SIM card stores contents such as information of digital mobile phone customers, secret keys for encryption, and telephone dictionary of users, may be used by an operator network to identify a customer's identity, and may encrypt voice information when the customer calls.

At present, due to the increasing expansion of smart devices of IOT, conventional entitative SIM cards have already been unable to meet requirements of some markets well. In order to distribute smart devices of IOT effectively, particularly, to meet requirements for terminal characteristics of various application scenarios and usage environments, the present disclosure provides a communication method for smart devices of IOT based on virtual SIM card technology.

Particularly, the virtual SIM cards are different from conventional entitative SIM cards, it does not have any SIM hardware entity. The virtual SIM stores SIM information in storage space of smart terminals or smart devices of IOT. Moreover, regarding SIM information in the entitative SIM card, users cannot change the information. However, regarding SIM information in the virtual SIM card, users may perform remote updating and management.

Preferably, the communication method for smart devices of IOT based on virtual SIM card technology provided by the present disclosure brings great convenience for users. The present disclosure realizes that a smart device of IOT without any entitative SIM card inserted therein still may perform mobile communication independently based on a virtual SIM card after leaving a smart terminal, and supports remote distribution and management for SIM information of the smart device of IOT.

Furthermore, by the present disclosure, the configuration of SIM card slots may be decreased from smart devices of IOT, not only are the space and production cost of smart devices of IOT saved, but also the appearances of smart devices of IOT may become more flexible, this is of great importance for smart devices of IOT, such as smart watches, motion recorders, smart meters, and so on, which have high requirements for volume and are inconvenient for inserting or replacing cards.

Furthermore, before the block S100, the present disclosure may further include the following block.

In block S10, after the smart terminal connects with the operator, the operator transmits SIM information resource to the smart terminal.

Particularly, the smart terminal may communicate with the corresponding operator by inserting an entitative SIM card therein, and may also communicate with the corresponding operator by a virtual SIM card (as detailed below).

Furthermore, in the block S100, the smart terminal receives SIM information resource allocated by the operator and transmits the SIM information resource to the corresponding smart device of TOT, specifically may include the following blocks.

In block S101, the smart terminal connects with the smart device of IOT through WIFI or Bluetooth.

In block S102, after the connection succeeds, the smart terminal transmits the received SIM information resource to the corresponding smart device of IOT through WIFI or Bluetooth.

Particularly, the smart terminal mainly uses application programs to manage and update SIM resource information in the virtual SIM card of the smart device of IOT. Before transmitting SIM information resource, the smart terminal may firstly inquire and display SIM information in the virtual SIM card of the smart device of TOT. After the inquiry is passed, whether there is a need for adding SIM information in the virtual SIM card of the smart device of IOT or updating SIM information in the virtual SIM card of the smart device of TOT is then determined.

Furthermore, in the block S200 of the present disclosure, the smart device of TOT writes the received SIM information resource into the virtual SIM card.

Next, in the block S300, the smart terminal transmits the activation instruction to the smart device of IOT.

Finally, in the block S400, the smart device of TOT activates the virtual SIM card according to the received activation instruction, and thus connects the corresponding operator network.

Furthermore, when the smart device of TOT needs to stop connecting the operator network, the smart terminal transmits de-activation instruction to the smart device of TOT, the smart device of TOT de-activates the virtual SIM card according to the de-activation instruction, and thus stops using the virtual SIM card to connect the operator network.

Furthermore, when the smart device of TOT needs to delete SIM information resource, the smart terminal transmits deletion instruction to the smart device of TOT, and the smart device of TOT deletes SIM information resource in the virtual SIM card according to the deletion instruction.

Furthermore, when the smart device of TOT needs to update the SIM information resource, the smart terminal transmits updated SIM information resource and updating instruction to the smart device of TOT, and the smart device of TOT replaces original SIM information resource in the virtual SIM card with the updated SIM information resource according to the updating instruction.

The above is a communication method for smart devices of TOT based on virtual SIM cards, of course, the present disclosure may also realize enabling a mobile phone to access a corresponding operator network based on a virtual SIM card. Particularly, the mobile phone receives SIM information transmitted by the operator through WIFI, the mobile phone manages the SIM information and writes the SIM information into the virtual SIM card of the mobile phone by a pre-installed application program, such that the virtual SIM card may perform a network access operation and use network services of the corresponding operator.

Based on the above method, the present disclosure may further provide a preferred embodiment of a system of smart devices of TOT based on virtual SIM cards, as shown in FIG. 2. This system may include a smart terminal 100 and a smart device of TOT 200. The smart terminal 200 may include a transceiver module 101 and an activation instruction transmission module 102, and the smart device of TOT 200 may include a writing module 201 and an activation module 202.

The transceiver module 101 may be configured to receive SIM information resource allocated by an operator and transmit the SIM information resource to the corresponding smart device of IOT.

The writing module 201 may be configured to write the received SIM information resource into a virtual SIM card.

The activation instruction transmission module 102 may be configured to transmit activation instruction to the smart device of IOT.

The activation module 202 may be configured to activate the virtual SIM card according to received activation instruction and thus connect a corresponding operator network.

Preferably, the communication system for smart devices of IOT based on virtual SIM cards may further include:

a transmission module configured for: after the smart terminal connects with an operator, the operator transmits SIM information to the smart terminal.

Preferably, in the communication system for smart devices of IOT based on virtual SIM cards, the transceiver module 101 may specifically include:

a connection unit configured to connect with the smart device of IOT through WIFI or Bluetooth;

a transmission unit configured to transmit the received SIM information resource to a corresponding smart device of IOT through WIFI or Bluetooth.

Preferably, in the communication system for smart devices of IOT based on virtual SIM cards, wherein

the smart terminal 100 may further include a de-activation instruction transmission module configured to transmit de-activation instruction to the smart device of IOT;

the smart device of IOT 200 may further include a de-activation module configured to de-activate the virtual SIM card according to the received de-activation instruction and thus stop using the virtual SIM card to connect the operator network.

Preferably, in the communication system for smart devices of IOT based on virtual SIM cards, wherein

the smart terminal 100 may further include a deletion instruction transmission module configured to transmit deletion instruction to the smart device of IOT;

the smart device of IOT 200 may further include a deletion module configured to delete SIM information resource in the virtual SIM card according to received deletion instruction.

Preferably, in the communication system for smart devices of IOT based on virtual SIM cards, wherein

the smart terminal 100 may further include an updating instruction transmission module configured to transmit updated SIM information resource and updating instruction to the smart device of IOT;

the smart device of IOT 200 may further include an updating module configured to replace original SIM information resource in the virtual SIM card with the updated SIM information resource according to the received updating instruction.

In conclusion, the communication method and system for smart devices of IOT based on virtual SIM cards provided by the present disclosure realizes that a smart device of IOT without any entitative SIM card inserted therein still may perform mobile communication independently based on a virtual SIM card after leaving a smart terminal, and supports remote distribution and management for SIM information of the smart device of IOT. By the present disclosure, the configuration of SIM card slots may be decreased from smart devices of IOT, not only are the space and production cost of smart devices of IOT saved, but also the appearances of smart devices of IOT may become more flexible, this is of great importance for smart devices of IOT, such as smart watches, motion recorders, smart meters, and so on, which have high requirements for volume and are inconvenient for inserting or replacing cards.

It should be understood that the application of present disclosure is not limited to the above embodiments. For one of ordinary skill in the art, improvements and changes can be performed according to the above illustration, and all of the improvements and changes should fall within the protection scope of the appending claims of the present disclosure.

1-4. (canceled)

5. A communication method for smart devices of IOT based on virtual SIM cards, comprising:
a smart terminal receiving SIM information resource allocated by an operator and transmitting the SIM information resource to a corresponding smart device of IOT;
the smart device of IOT writing the received SIM information resource into a virtual SIM card;
the smart terminal transmitting activation instruction to the smart device of IOT;
the smart device of IOT activating the virtual SIM card according to the received activation instruction, and connecting a corresponding operator network.

6. The communication method for smart devices of IOT based on virtual SIM cards according to claim 5, before the smart terminal receiving SIM information resource allocated by an operator and transmitting the SIM information resource to a corresponding smart device of IOT, further comprising:
the operator transmitting SIM information resource to the smart terminal after connecting with the smart terminal.

7. The communication method for smart devices of IOT based on virtual SIM cards according to claim 5, wherein the smart terminal receiving SIM information resource allocated by an operator and transmitting the SIM information resource to a corresponding smart device of IOT specifically comprises:
the smart terminal connects with the smart device of IOT through WIFI or Bluetooth;
the smart terminal transmits the received SIM information resource to the corresponding smart device of IOT through WIFI or Bluetooth after the connection succeeds.

8. The communication method for smart devices of IOT based on virtual SIM cards according to claim 5, after the smart device of IOT activating the virtual SIM card according to the received activation instruction, and connecting a corresponding operator network, further comprising:
the smart terminal transmitting de-activation instruction to the smart device of IOT, and the smart device of IOT de-activating the virtual SIM card according to the de-activation instruction, and stopping using the virtual SIM card to connect the operator network.

9. The communication method for smart devices of IOT based on virtual SIM cards according to claim 5, after the smart device of IOT activating the virtual SIM card according to the received activation instruction, and connecting a corresponding operator network, further comprising:
the smart terminal transmitting deletion instruction to the smart device of IOT, and the smart device of IOT deleting the SIM information resource in the virtual SIM card according to the deletion instruction.

10. The communication method for smart devices of IOT based on virtual SIM cards according to claim 5, after the smart device of IOT activating the virtual SIM card according to the received activation instruction, and connecting a corresponding operator network, further comprising:
the smart terminal transmitting updated SIM information resource and updating instruction to the smart device of TOT, and the smart device of IOT replacing original SIM information resource in the virtual SIM card with the updated SIM information resource according to the updating instruction.

11-14. (canceled)

15. A communication system for smart devices of IOT based on virtual SIM cards, comprising a smart terminal and a smart device of TOT, the smart terminal comprising a transceiver, the smart device of IOT comprising a storage and a processor; wherein
the transceiver is configured to receive SIM information resource allocated by an operator and transmit the SIM information resource to the smart device of TOT;
the processor is configured to write the received SIM information resource into the storage;
the transceiver is configured to transmit activation instruction to the smart device of TOT;
the processor is configured to activate the storage according to the received activation instruction and thus connect a corresponding operator network.

16. The communication system for smart devices of IOT based on virtual SIM cards according to claim 15, wherein
the transceiver is further configured to transmit de-activation instruction to the smart device of IOT;
the processor is further configured to de-activate the storage according to the received de-activation instruction and thus stop using the storage to connect the operator network.

17. The communication system for smart devices of IOT based on virtual SIM cards according to claim 15, wherein
the transceiver is further configured to transmit deletion instruction to the smart device of IOT;
the processor is further configured to delete the SIM information resource in the storage according to the received deletion instruction.

18. The communication system for smart devices of IOT based on virtual SIM cards according to claim 15, wherein
the transceiver is further configured to transmit updated SIM information resource and updating instruction to the smart device of IOT;
the processor is further configured to replace original SIM information resource in the storage with the updated SIM information resource according to the received updating instruction.

19. A communication method for smart devices of IOT based on virtual SIM cards, comprising:
receiving SIM information resource transmitted by a smart terminal;
writing the received SIM information resource into a virtual SIM card;
receiving activation instruction transmitted by the smart terminal;
activating the virtual SIM card according to the received activation instruction, and connecting a corresponding operator network.

20. The communication method for smart devices of IOT based on virtual SIM cards according to claim 19, before the receiving SIM information resource transmitted by the smart terminal further comprising: the operator transmitting SIM information resource to the smart terminal after connecting with the smart terminal.

21. The communication method for smart devices of IOT based on virtual SIM cards according to claim 19, wherein the receiving SIM information resource transmitted by the smart terminal specifically comprises:
connect with the smart terminal through WIFI or Bluetooth;
receive SIM information resource through WIFI or Bluetooth after the connection succeeds.

22. The communication method for smart devices of IOT based on virtual SIM cards according to claim 19, further comprising:
receiving de-activation instruction transmitted by the smart terminal, and de-activating the virtual SIM card according to the de-activation instruction, thus stopping using the virtual SIM card to connect the operator network.

23. The communication method for smart devices of IOT based on virtual SIM cards according to claim 19, further comprising:
receiving deletion instruction transmitted by the smart terminal, and deleting the SIM information resource in the virtual SIM card according to the deletion instruction.

24. The communication method for smart devices of IOT based on virtual SIM cards according to claim 19, further comprising:
receiving updated SIM information resource and updating instruction transmitted by the smart terminal, and replacing original SIM information resource in the virtual SIM card with the updated SIM information resource according to the updating instruction.
